(19) United States
(12) Patent Application Publication
(10) Pub. No.: US 2022/0372908 A1
(43) Pub. Date: Nov. 24, 2022

(54) OPERATION OF AN INTERNAL COMBUSTION ENGINE HAVING AN ELECTRIC FRESH GAS COMPRESSOR AND HAVING AN EXHAUST TURBINE WITH A BYPASS LINE AND VTG

(71) Applicant: Volkswagen Aktiengesellschaft, Wolfsburg (DE)

(72) Inventor: Simon SIPPEL, Kneitlingen (DE)

(73) Assignee: Volkswagen Aktiengesellschaft, Wolfsburg (DE)

(21) Appl. No.: 17/748,951

(22) Filed: May 19, 2022

(30) Foreign Application Priority Data
May 20, 2021 (DE) 10 2021 205 167.7

(51) Int. Cl. F02B 37/04; F02B 37/22; F02B 37/18; F01N 3/023; F01N 3/20

(52) U.S. Cl. CPC F02B 37/04; F02B 37/22; F02B 37/18; F01N 3/023; F01N 3/2006

(57) ABSTRACT

A method for operating an internal combustion engine, which comprises a combustion engine, a fresh gas line into which a fresh gas compressor is integrated, wherein the fresh gas compressor can be driven by an electric motor, and an exhaust gas line, in which an exhaust turbine, which has a variable turbine geometry, a bypass line with a bypass valve for bypassing the exhaust turbine as required, and, downstream of the exhaust turbine and the bypass line, an exhaust gas aftertreatment component are integrated, wherein if, during operation of the combustion engine, an operating temperature of the exhaust gas aftertreatment component is below a set temperature, the bypass line is at least temporarily released, the fresh gas compressor is driven by the electric motor, and the VTG is set to a closed position of at least 50% or at least 80% or at least 90% or 100%.

This nonprovisional application claims priority under 35 U.S.C. § 119(a) to German Patent Application No. 10 2021 205 167.7, which was filed in Germany on May 20, 2021, and which is herein incorporated by reference.

### BACKGROUND OF THE INVENTION

### Field of the Invention

The present invention relates to a method for operating an internal combustion engine, wherein an exhaust gas aftertreatment component of the internal combustion engine has an operating temperature that is below a set temperature.

### Description of the Background Art

In order to realize the lowest possible pollutant emissions from an internal combustion engine, the exhaust gas aftertreatment components of an exhaust gas aftertreatment device, said component being integrated into an exhaust gas line of the internal combustion engine. should as far as possible always have operating temperatures above the respective start-up temperatures (also known as light-off temperatures) at which a sufficient effectiveness with regard to the intended exhaust gas aftertreatment can be assumed. After a cold start of the internal combustion engine, in which the exhaust gas aftertreatment components have operating temperatures that are significantly below the respective light-off temperatures, the operating temperatures of at least some of the exhaust gas aftertreatment components should reach the respective light-off temperature as quickly as possible. To ensure this, it is known to actively heat individual exhaust gas aftertreatment components. On the one hand, this is possible by means of heating devices provided for this purpose, which can comprise, for example, electric heating elements or be designed as burners. Furthermore, so-called in-engine measures can be implemented, which aim to generate relatively hot exhaust gas through targeted operation of the combustion engine with a relatively poor efficiency, so that a relatively rapid heating of the exhaust gas aftertreatment components can be achieved via the exhaust gas.

DE 10 2019 200 418 A1 discloses influencing the amount of energy remaining in the exhaust gas downstream of an exhaust turbine by means of an electric machine acting on an exhaust turbocharger of an internal combustion engine and optionally operating as an electric motor or generator. A process comparable thereto is also disclosed in US 2006/0236692 A1.

DE 10 2018 117 913 A1, which corresponds to US 2019/0032585, describes a method for regenerating a particulate filter of an internal combustion engine, wherein additional air is introduced into the exhaust gas via a blower and additional fuel is injected into the exhaust gas line of the internal combustion engine via an injection device in order to raise the exhaust gas temperature by oxidizing the fuel with oxygen in the air.

An exhaust system for a motor vehicle according to DE 10 2019 102 013 A1 comprises an exhaust manifold, an exhaust turbine of an exhaust turbocharger, said turbine being connected downstream to the exhaust manifold, and an exhaust gas aftertreatment device connected downstream to the exhaust turbine, wherein the exhaust turbocharger has a bypass duct, which can be actuated by means of a wastegate valve, for controlling the boost pressure of the exhaust turbocharger. Furthermore, a short-circuit line is provided which is connected to the exhaust manifold and to the exhaust gas aftertreatment device and can be actuated by means of a short-circuit valve. Due to the lower heat sink effect of the short-circuit line compared to the exhaust turbocharger, the exhaust gas aftertreatment device can be heated more quickly to its light-off temperature if exhaust gas is routed via the short-circuit line as required and thus does not flow through the exhaust turbine.

### SUMMARY OF THE INVENTION

It is therefore an object of the present invention to provide/achieve the fastest possible heating of an exhaust gas aftertreatment component of an internal combustion engine to a set temperature, in particular after a cold start.

According to an exemplary embodiment of the invention, a method is provided for operating an internal combustion engine comprising a combustion engine, a fresh gas line, and an exhaust gas line. At least one fresh gas compressor is integrated into the fresh gas line, wherein the fresh gas compressor can be driven by an electric motor. At least one exhaust turbine, which has a variable turbine geometry (VTG), a bypass line with a bypass valve for bypassing the exhaust turbine as required, and, downstream of the exhaust turbine and the bypass line, at least one exhaust gas aftertreatment component are integrated into the exhaust gas line. If, during operation of the combustion engine, an operating temperature of the exhaust gas aftertreatment component is below a set temperature, the bypass line is at least temporarily released (by an at least partial and preferably complete opening of the bypass valve). Furthermore, the fresh gas compressor is then driven by the electric motor and the VTG is set to a relatively large extent, in particular to a closed position of at least 50% or at least 80% or at least 90% or 100% (and held in the corresponding closed position or the intended closure range).

To implement a VTG, an exhaust turbine comprises a device by means of which a flow cross section via which exhaust gas can be guided to a turbine wheel of the exhaust turbine can be varied with regard to efficiency. For this purpose, at least the size of the free flow cross section and preferably also the angle of the inflow of the turbine wheel blades can be varied. The more closed the VTG, the smaller the free flow cross section for the turbine wheel inflow. The percentage of the closed position can therefore refer to the ratio of the free flow cross section still present in the respective closed position of the VTG compared to the maximum free flow cross section (in the fully open or 0% closed position). Alternatively, the percentage of the closed position can refer to the strength of triggering an actuator by means of which the VTG can be adjusted, whereby this control preferably takes place by means of pulse width modulation (PWM).

The method of the invention aims to achieve the fastest possible heating of the exhaust gas aftertreatment component until at least the set temperature is reached by routing the exhaust gas emitted by the combustion engine at least partially and preferably as completely as possible via the bypass line and thus not via the exhaust turbine. The at least partially and preferably largely or completely closed VTG of the exhaust turbine ensures that the resistance for the exhaust gas to flow through the exhaust turbine is as high as possible, so that the exhaust gas chooses the lower-resistance path via the bypass line as far as possible. By routing as much of the exhaust gas as possible via the bypass line, it can be achieved that this exhaust gas still has as high a temperature as possible when it flows through the exhaust gas aftertreatment component. In this regard, not only is cooling of this exhaust gas avoided, which would occur as a result of expansion in the exhaust turbine, but also cooling resulting from the exhaust turbine, which usually has a considerable thermal mass, being heated by the exhaust gas. In contrast, the bypass line can have a significantly smaller thermal mass, so that the cooling of the exhaust gas as it flows through the bypass line can be kept correspondingly low.

If, according to the invention, the exhaust gas is temporarily routed past the exhaust turbine, only little or no drive power is provided by the exhaust turbine that could be used to drive the fresh gas compressor directly or indirectly. Against this background, an internal combustion engine operated according to the invention also comprises an electric motor for driving the fresh gas compressor, so that sufficient compression of the fresh gas to be fed to the combustion engine can be achieved even if the exhaust gas is temporarily routed via the bypass line and thus past the exhaust turbine.

The set temperature can preferably be a light-off temperature of the exhaust gas aftertreatment component, above which it is assumed that the exhaust gas aftertreatment component is sufficiently effective with regard to the exhaust gas aftertreatment specific to it. According to the invention, it can therefore be provided to route the exhaust gas via the bypass line with the aim of heating up the exhaust gas aftertreatment component as quickly as possible when the internal combustion engine is in a warm-up operating phase, which is characterized by the fact that at least the one exhaust gas aftertreatment component has an operating temperature which is below the associated light-off temperature. The warm-up operating phase can follow a cold start of the internal combustion engine, wherein “cold start” means a start-up of the internal combustion engine in which at least the exhaust gas aftertreatment component has an operating temperature which corresponds approximately (i.e., also with a deviation of up to 10 K, 20 K, or 30 K) to the ambient temperature. Preferably, accordingly, within the scope of a method of the invention, therefore, it can be provided to route the exhaust gas via the bypass line immediately after a cold start of the internal combustion engine with the aim of heating the exhaust gas aftertreatment component as quickly as possible. However, a warm-up operating phase does not always have to follow a cold start or a start-up of the internal combustion engine with an operating temperature of the exhaust gas aftertreatment component below the light-off temperature; rather, a warm-up operating phase can also begin with the internal combustion engine, and in particular the combustion engine, having previously been operated in such a way that the light-off temperature, which has already been exceeded previously, is again undershot to a defined extent, as can be the case optionally during a longer period of idling or overrun operation of the combustion engine.

The set temperature taken into account in a method of the invention can also be a regeneration temperature of the exhaust gas aftertreatment component, so that heating up the exhaust gas aftertreatment component, which according to the invention is supported by a flow of still relatively hot exhaust gas, can serve to again increase by means of thermal regeneration the efficiency of the exhaust gas aftertreatment component with regard to the exhaust gas aftertreatment specific to it, which has decreased as a result of a previous operation of the internal combustion engine.

The fresh gas compressor and the exhaust turbine of an internal combustion engine operated in accordance with the invention can preferably be mechanically coupled, so that there is a mechanical drive connection between these components corresponding to the basic design of an exhaust turbocharger. A rotation of a turbine wheel of the exhaust turbine resulting from a flow of exhaust gas through the exhaust turbine can consequently lead directly to a rotation of a compressor wheel of the fresh gas compressor. This represents a structurally simple and effective option for driving the fresh gas compressor. The electric motor assigned to the fresh gas compressor can then only be provided for temporarily driving the fresh gas compressor or the exhaust turbocharger, as a result of which it as well can have a relatively simple structural design.

In the operation of an internal combustion engine with such an exhaust turbocharger according to the invention, it can preferably be provided that the VTG is set to the 100% closed position when the bypass line is released in order to supply exhaust gas that is as hot as possible to the exhaust gas aftertreatment component and when the fresh gas compressor is driven by means of the electric motor in order to provide sufficient compression of the fresh gas for the operation of the combustion engine. In this way, a possible suction effect that the exhaust turbine has on the exhaust gas due to the driving of the fresh gas compressor by means of the electric motor, which is also transmitted to the exhaust turbine by the mechanical coupling, can be kept to a minimum and accordingly it can be ensured that as much of the exhaust gas as possible is routed via the bypass line.

The fresh gas compressor and the exhaust turbine of an internal combustion engine operated according to the invention can also be mechanically decoupled, for example, in that the fresh gas compressor can be driven exclusively by means of the electric motor, whereas the exhaust turbine is mechanically coupled to an electric machine, which can at least also be operated as a generator, and/or to another fresh gas compressor. The electric power to drive the electric motor associated with the fresh gas compressor can then be provided by the electric machine associated with the exhaust turbine and/or by an electric machine mechanically coupled to the combustion engine, wherein intermediate storage of electrical energy can also be provided in a storage device which is integrated in an electrical connection between the electric machine(s) and the electric motor.

In the operation of an internal combustion engine according to the invention with such a mechanical decoupling of the fresh gas compressor and the exhaust turbine, it can be useful for the VTG not to be set to the 100% closed position or to a position closed less than 100% when the bypass line is released in order to supply the exhaust gas aftertreatment component with exhaust gas that is as hot as possible, and when the fresh gas compressor is driven by means of the electric motor to provide sufficient compression of the fresh gas to operate the combustion engine. It can be ensured thereby that the exhaust turbine is driven somewhat but continuously by a relatively low mass flow rate of the exhaust gas flowing through it. Disadvantages that could result from a complete shutdown of the exhaust turbine can thus be avoided. These disadvantages can be, in particular, an interruption of a hydrodynamic lubrication of the exhaust turbine, as a result of which, when operation of the exhaust turbine is resumed, a relatively large amount of wear can occur for a short time, which can have a detrimental effect on the lifetime of the exhaust turbine.

In order to achieve the most advantageous possible pollutant emission behavior of an internal combustion engine of the invention, it can preferably be provided that when the bypass line is released, in order to supply the exhaust gas aftertreatment component with the hottest possible exhaust gas and, when the fresh gas compressor is driven by means of the electric motor, in order to provide sufficient compression of the fresh gas for the operation of the combustion engine, exhaust gas is at least temporarily branched off from the exhaust gas line and introduced into the fresh gas line via an exhaust gas recirculation line connecting the exhaust gas line to the fresh gas line. Exhaust gas recirculation of this kind can be particularly advantageous in terms of the raw nitrogen oxide emissions of the combustion engine.

Furthermore, it can be provided preferably that in order to realize a so-called low-pressure exhaust gas recirculation, the exhaust gas can be branched off from the exhaust gas line downstream (with respect to the direction of the exhaust gas flow from the combustion engine) of the exhaust turbine and introduced into the fresh gas line upstream (with respect to the direction of the fresh gas flow in the direction of the combustion engine) of the fresh gas compressor. Alternatively, however, a so-called high-pressure exhaust gas recirculation can be implemented, in which the exhaust gas is branched off from the exhaust gas line upstream of the exhaust turbine and fed into the fresh gas line downstream of the fresh gas compressor. In this case, however, measures would have to be provided, if necessary, that prevent that the fresh gas overflows from the fresh gas line into the exhaust gas line via the (high-pressure) exhaust gas recirculation line when the fresh gas compressor is driven by an electric motor during operation of the internal combustion engine according to the invention, so that there is a correspondingly high boost pressure in the region of an opening of the exhaust gas recirculation line into the fresh gas line, whereas in the region of a branching of the exhaust gas recirculation line from the exhaust gas line there is a relatively low exhaust gas pressure (and consequently a pressure drop across the exhaust gas recirculation line from the fresh gas line to the exhaust gas line) as a result of the release of the bypass line. Operation of an internal combustion engine according to the invention with such a (high-pressure) exhaust gas recirculation can therefore possibly require that when there is such a pressure drop across the exhaust gas recirculation line, the exhaust gas recirculation line is temporarily closed by means of a valve integrated into it.

The combustion engine of an internal combustion engine of the invention can preferably be a (compression-ignition and quality-controlled) diesel engine or a (spark-ignition and quantity-controlled) gasoline engine or a combination thereof, i.e., e.g., a combustion engine with homogeneous compression ignition. The combustion engine can be operated both with liquid fuel (i.e., diesel or gasoline) and also with a gaseous fuel (in particular natural gas, LNG, or LPG).

The invention also relates to a motor vehicle, in particular a wheel-based and non-rail-bound motor vehicle (preferably a passenger car or a truck), with an internal combustion engine operated in accordance with the invention, or to the operation of a motor vehicle of this kind. In this case, the combustion engine of the internal combustion engine can be provided in particular for the (direct or indirect) provision of the drive power for the motor vehicle.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an internal combustion engine that can be operated according to the invention in a simplified representation;

FIG. 2 shows the time curves of the exhaust gas temperature T₃ upstream of an exhaust turbine for three differently operated internal combustion engines during the same operating cycle;

FIG. 3 shows corresponding curves of the mass flow rate \dot{m}_{AT} of the exhaust gas through the respective exhaust turbine for the three internal combustion engines;

FIG. 4 shows corresponding curves of a temperature T_{AT} of the respective exhaust turbine of the three internal combustion engines;

FIG. 5 shows corresponding curves of the operating temperature T_{PF} of a particulate filter of the three internal combustion engines; and

FIG. 6 shows corresponding curves of the fuel consumption FC of a combustion engine of the three internal combustion engines.

### DETAILED DESCRIPTION

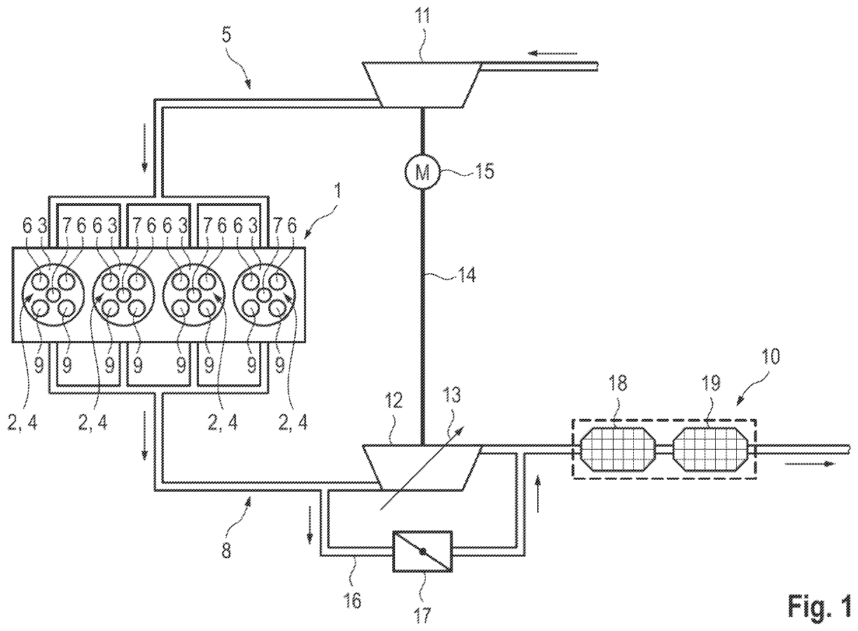

FIG. 1 shows a motor vehicle internal combustion engine suitable for operation in accordance with the invention. It comprises a combustion engine 1, which by way of example is designed in the form of a reciprocating piston engine with four cylinder ports 2 arranged in series. Cylinder ports 2 each define a combustion chamber 4 with reciprocating pistons 3, movably guided therein, and with a cylinder head (not shown). Fresh gas is supplied to these combustion chambers 4 via a fresh gas line 5 during operation of combustion engine 1 and thus of the internal combustion engine, wherein the feeding of the fresh gas is controlled by means of inlet valves 6 associated with the individual combustion chambers 4. The fresh gas is exclusively or mainly air that has been drawn in from the environment. Exhaust gas arising during the combustion of mixture quantities, including the fresh gas as well as fuel injected directly into combustion chambers 4 via fuel injectors 7, is discharged via an exhaust gas line 8 of the internal combustion engine, wherein the removal of the exhaust gas is controlled by means of outlet valves 9 also associated with the individual combustion chambers 4. The exhaust gas here flows through an exhaust gas aftertreatment device 10, which is designed to remove exhaust gas components that are considered pollutants from the exhaust gas or to convert them into harmless components.

Ignition of the mixture quantities in combustion chambers 4 can take place by means of electrical ignition devices (not shown), which generate ignition sparks (spark plugs), for example, or by compression ignition.

The internal combustion engine is designed as supercharged, for which purpose a fresh gas compressor 11 is integrated into fresh gas line 5. Fresh gas compressor 11 is part of an exhaust turbocharger, which further comprises an exhaust turbine 12, integrated into exhaust gas line 8, with variable turbine geometry (VTG) 13. Exhaust gas flowing through exhaust turbine 12 leads to a rotating drive of a turbine wheel (not shown), which is connected to a compressor wheel (not shown) of fresh gas compressor 11 via a shaft 14 in a rotationally driven manner, so that as a result driving of fresh gas compressor 11 can occur by means of exhaust turbine 12. The exhaust turbocharger further comprises an electric motor 15, which is mechanically coupled to shaft 14 and by means of which shaft 14 and thus also the compressor wheel of fresh gas compressor 11 (as well as the turbine wheel of exhaust turbine 12) can be driven in a rotating manner as needed.

Exhaust gas line 8 further comprises a bypass line 16 with a bypass valve 17, which branches off immediately upstream of exhaust turbine 12 from a main line of exhaust gas line 8, said main line integrating exhaust turbine 12, and rejoins the main line of exhaust gas line 8 immediately downstream of exhaust turbine 12 and thus upstream of exhaust gas aftertreatment device 10. When bypass valve 17 is open, exhaust gas is routed via bypass line 16, whereby this exhaust gas bypasses exhaust turbine 12 or does not flow through it.

Exhaust gas aftertreatment device 10 can comprise, for example, an exhaust gas aftertreatment component in the form of an oxidation catalyst 18 and, downstream of oxidation catalyst 18, an exhaust gas aftertreatment component in the form of a particulate filter 19.

If, during the operation of combustion engine 1, at least one of these exhaust gas aftertreatment components has an operating temperature that is below a defined set temperature, the invention provides for at least temporarily releasing bypass line 16 by at least partially and preferably completely opening bypass valve 17 and for setting VTG 13 to a 100% closed position or a position closed as far as possible. It can be achieved thereby that, as far as possible, all the exhaust gas coming from combustion engine 1 is routed via bypass line 16 and thereby bypasses exhaust turbine 12. In this way, it can be avoided that the exhaust gas is largely cooled down as a result of a flow through exhaust turbine 12, which would be attributable, on the one hand, to an expansion by exhaust turbine 12 and, on the other hand, to a transfer of thermal energy for heating the also still relatively cold exhaust turbine 12, which has a relatively large thermal mass. In contrast, bypass line 16 has a relatively small thermal mass, so that flow through bypass line 16 results in only a relatively little cooling of the exhaust gas. Accordingly, the exhaust gas enters exhaust gas aftertreatment device 10 with a relatively high temperature and can thereby lead to a fastest possible heating of exhaust gas aftertreatment device 10 or the exhaust gas aftertreatment components comprised by it until at least the respective set temperature is reached.

Because due to the bypassing, exhaust turbine 12 generates no or hardly any drive power for fresh gas compressor 11 by means of the exhaust gas, during this operation of the internal combustion engine the fresh gas compressor (and due to the mechanical coupling with exhaust turbine 12, exhaust turbine 12 as well) is driven by means of electric motor 15 depending on the demand of combustion engine 1 for fresh gas. As a result, it can be avoided that the bypassing of exhaust turbine 12 leads to disadvantages in the operating behavior with regard to the exhaust gas flow and, in particular, also with regard to the power output of combustion engine 1.

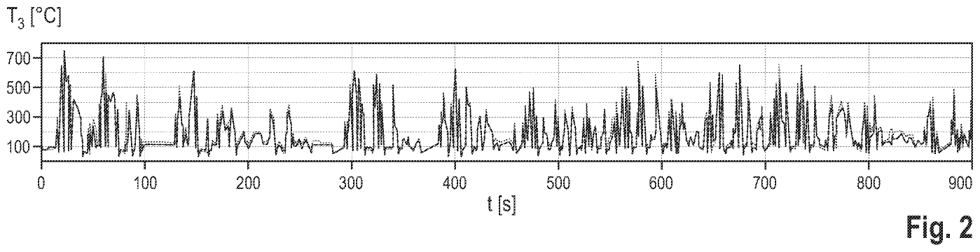

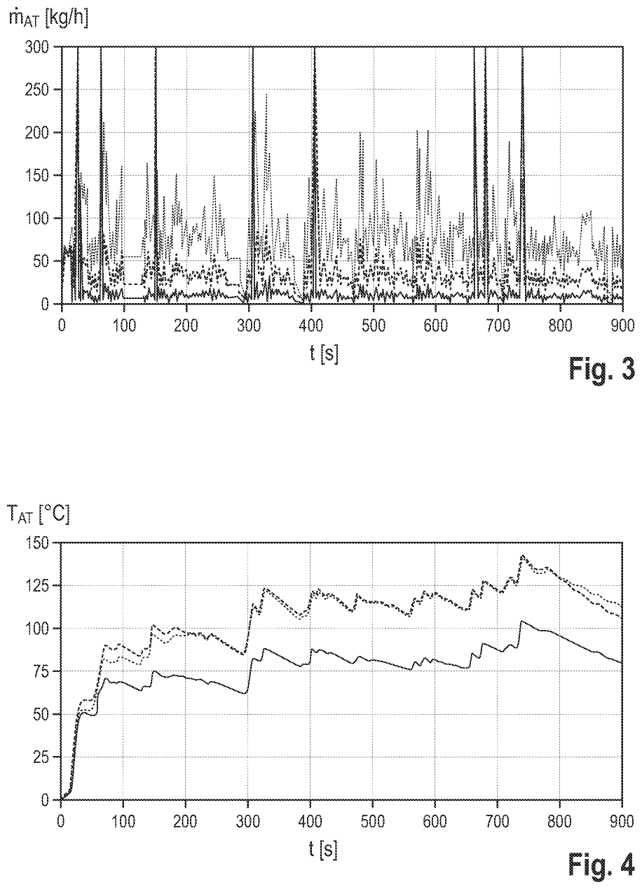

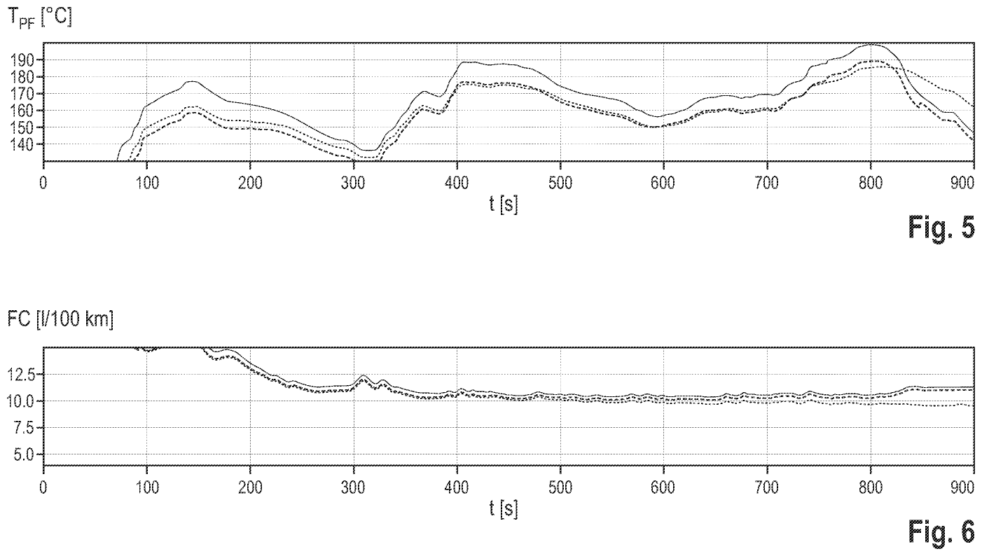

FIGS. 2 to 6 illustrate this method of the invention and the advantages achievable thereby by means of time curves with respect to the temperature T₃ of the exhaust gas upstream of exhaust turbine 12 (cf. FIG. 2), with respect to the mass flow rate \dot{m}_{AT} of the exhaust gas through exhaust turbine 12 (cf. FIG. 3), with respect to a temperature T_{AT} of exhaust turbine 12 (cf. FIG. 4), with respect to the operating temperature T_{PF} of particulate filter 19 (cf. FIG. 5), and with respect to the fuel consumption FC of combustion engine 1 related to a mileage of a motor vehicle comprising the internal combustion engine (cf. FIG. 6), in each case during an operating cycle of the internal combustion engine in a warm-up operating phase immediately following a cold start of the internal combustion engine at t=0.

These curves are each shown with solid lines for an operation of the invention of an internal combustion engine according to, for example, FIG. 1; i.e., exhaust gas is routed continuously via bypass line 16 during operation. Furthermore, fresh gas compressor 11 is driven by means of electric motor 15 if and as required and VTG 13 is set to a 95% closed position.

The dashed lines, on the other hand, show the curves with respect to the operation of the same internal combustion engine in which the exhaust gas is also routed via bypass line 16 and fresh gas compressor 11 is driven by electric motor 15 if and as required, but in which VTG 13 is set to a fully open or 0% closed position.

And the dotted lines show the curves with respect to the operation of an internal combustion engine in which no electric motor 15 is associated with the exhaust turbocharger and in which the compression required for the operation of combustion engine 1 according to the operating cycle by means of the fresh gas compressor is carried out exclusively using drive power provided by means of exhaust turbine 12, wherein VTG 13 or exhaust turbine 12 is adjusted depending on the demand of fresh gas compressor 11 for drive power. The entire exhaust gas is always routed via exhaust turbine 12. Otherwise, this internal combustion engine corresponds to the other internal combustion engine.

The operating cycle extends over a period of 900 seconds and is characterized by a variable operation of combustion engine 1, which, according to FIG. 2, results in a highly fluctuating temperature T₃ of the exhaust gas upstream of exhaust turbine 12. The curves of the exhaust gas temperature T₃ for the different internal combustion engines or the different operating modes of the internal combustion engines are substantially congruent in this case.

However, according to FIG. 3, the different operating modes result in significantly different mass flow rates of the exhaust gas through exhaust turbine 12. It can be seen that the mass flow rate of the exhaust gas through the internal combustion engine operated according to the invention is again significantly reduced compared with that in which bypass line 16 is released but VTG 13 is also open at the same time. This has the result that exhaust turbine 12 of the internal combustion engine operated according to the invention heats up much more slowly and also to a lesser extent in the course of the operating cycle (cf. FIG. 4), whereas the operating temperature T_{PF} of particulate filter 19 of this internal combustion engine rises much faster and also to higher values (cf. FIG. 5). Accordingly, a significantly faster heating of particulate filter 19 or of the entire exhaust gas aftertreatment device 10 can be realized by operating the internal combustion engine according to the invention. A disadvantage here may possibly be a slightly higher fuel consumption of combustion engine 1, which may be due to the fact that the electrical power required to operate electric motor 15 driving fresh gas compressor 11 must essentially be generated by means of a generator-driven electric machine (not shown in FIG. 1) mechanically coupled to combustion engine 1, which may result in a higher load during operation of combustion engine 1. In the case of the internal combustion engine, in which the exhaust gas is also (partially) routed via bypass line 16 but in which VTG 13 is kept open, in contrast, a higher proportion of the exhaust gas flows through the exhaust turbine (cf. FIG. 3), whereby, as a result of the mechanical coupling with fresh gas compressor 11, this covers part of the demand for drive power for fresh gas compressor 11, so that correspondingly less drive power has to be provided by electric motor 15.

The invention being thus described, it will be obvious that the same may be varied in many ways. Such variations are not to be regarded as a departure from the spirit and scope of the invention, and all such modifications as would be obvious to one skilled in the art are to be included within the scope of the following claims

What is claimed is:

1. A method for operating an internal combustion engine, the comprising:
providing the internal combustion engine;
providing a fresh gas line into which a fresh gas compressor is integrated, wherein the fresh gas compressor is adapted to driven by an electric motor;
providing an exhaust gas line, in which an exhaust turbine, which has a variable turbine geometry, a bypass line with a bypass valve for bypassing the exhaust turbine as required, and, downstream of the exhaust turbine and the bypass line, an exhaust gas aftertreatment component are integrated; and
determining if, during operation of the combustion engine, an operating temperature of the exhaust gas aftertreatment component is below a set temperature, then: the bypass line is at least temporarily released, the fresh gas compressor is driven by the electric motor, and the VTG is set to a closed position of at least 50% or at least 80% or at least 90% or 100%.

2. The method according to claim 1, wherein the set temperature is a light-off temperature of the exhaust gas aftertreatment component.

3. The method according to claim 1, wherein the set temperature is a regeneration temperature of the exhaust gas aftertreatment component.

4. The method according to claim 1, wherein immediately after a cold start of the internal combustion engine, the fresh gas compressor (11) is driven by the electric motor and the VTG is set to the closed position of at least 50% or at least 80% or at least 90% or 100%.

5. The method according to claim 1, wherein the fresh gas compressor and the exhaust turbine are mechanically coupled.

6. The method according to claim 5, wherein the VTG is set to the 100% closed position.

7. The method according to claim 1, wherein the fresh gas compressor and the exhaust turbine are mechanically decoupled.

8. The method according to claim 1, wherein the VTG is set to a position closed less than 100%.

9. The method according to claim 1, wherein, when the bypass line is released, the fresh gas compressor is driven by the electric motor and the VTG is set to the closed position of at least 50% or at least 80% or at least 90% or 100%, the exhaust gas is at least temporarily branched off from the exhaust gas line and introduced into the fresh gas line.

10. The method according to claim 9, wherein the exhaust gas is branched off from the exhaust gas line downstream of the exhaust turbine and introduced into the fresh gas line upstream of the fresh gas compressor.

11. A vehicle comprising:
an internal combustion engine;
a fresh gas line into which a fresh gas compressor is integrated, wherein the fresh gas compressor is adapted to driven by an electric motor; and
an exhaust gas line, in which an exhaust turbine, which has a variable turbine geometry, a bypass line with a bypass valve for bypassing the exhaust turbine as required, and, downstream of the exhaust turbine and the bypass line, an exhaust gas aftertreatment component are integrated,
wherein, during operation of the combustion engine, an operating temperature of the exhaust gas aftertreatment component is below a set temperature, then:
the bypass line is at least temporarily released;
the fresh gas compressor is driven by the electric motor; and
the VTG is set to a closed position of at least 50% or at least 80% or at least 90% or 100%.
